(19) United States
(12) Patent Application Publication
(10) Pub. No.: US 2011/0217079 A1
(43) Pub. Date: Sep. 8, 2011

(54) IMAGE FORMING APPARATUS AND METHOD OF ADJUSTING GAP BETWEEN ROLLERS

(75) Inventor: Jun ISHII, Shizuoka-ken (JP)

(73) Assignees: Kabushiki Kaisha Toshiba, Tokyo (JP); Toshiba Tec Kabushiki Kaisha, Tokyo (JP)

(21) Appl. No.: 13/037,232

(22) Filed: Feb. 28, 2011

Related U.S. Application Data
(60) Provisional application No. 61/310,159, filed on Mar. 3, 2010.

(51) Int. Cl. G03G 15/02; G03G 15/08

(52) U.S. Cl. 399/168; 399/283

(57) ABSTRACT

According to one embodiment, an image forming apparatus includes a first roller, a second roller, and a separating mechanism. The first roller is formed in a longitudinal shape. The second roller is formed in a longitudinal shape and arranged in parallel to the first roller via a gap. The separating mechanism moves the second roller in a direction further away from the first roller such that the gap between the first roller and the second roller in a direction orthogonal to the axis direction of the second roller increases.

### CROSS-REFERENCE TO RELATED APPLICATION

This application is based upon and claims the benefit of priority from U.S. provisional application 61/310,159, filed on Mar. 3, 2010; the entire contents of which are incorporated herein by reference.

### FIELD

Embodiments described herein relate generally to an image forming apparatus and a technique for adjusting a gap between rollers.

### BACKGROUND

In the past, a non-contact charging roller has been known that is arranged to be opposed to a photoconductive member via a very small gap and discharges in the gap to charge the photoconductive member. In general, the gap is set to be equal to or smaller than 50 μm. Therefore, in an image forming apparatus including the non-contact charging roller, it is likely that a toner and foreign matters such as dust are caught in the gap between the charging roller and the photoconductive member and an image failure occurs.

### DESCRIPTION OF THE DRAWINGS

FIG. 1 is a perspective view of an image forming apparatus;

FIG. 2 is a schematic diagram of an image forming section;

FIG. 3 is a diagram of a photoconductive member, a charging roller, and a separating mechanism;

FIG. 4 is an enlarged sectional view of a charging roller shaft section and the separating mechanism;

FIG. 5 is a perspective view of a conical surface moving mechanism;

FIG. 6 is a diagram of a state in which a slope pushes a conical surface section;

FIG. 7 is a sectional view of the conical surface section running onto a pressing surface;

FIG. 8 is a perspective view of the conical surface section running onto the pressing surface;

FIG. 9 is a diagram of the conical surface section running onto the pressing surface;

FIG. 10 is a flowchart for explaining approach and separation control by a control section;

FIG. 11 is a diagram of a modification of the conical surface section that supports only one side of the charging roller;

FIG. 12 is a diagram of a modification of a contact and separation section; and

FIG. 13 is a diagram of a modification of the contact and separation section and the conical surface section.

### DETAILED DESCRIPTION

In general, according to one embodiment, an image forming apparatus includes a first roller, a second roller, and a separating mechanism. The first roller is formed in a longitudinal shape. The second roller is formed in a longitudinal shape and arranged in parallel to the first roller via a gap. The separating mechanism moves the second roller in a direction further away from the first roller such that the gap between the first roller and the second roller in a direction orthogonal to the axis direction of the second roller increases.

In general, according to another embodiment, a gap adjusting method is a method of adjusting, in an image forming apparatus including a first roller formed in a longitudinal shape and a second roller formed in a longitudinal shape and arranged in parallel to the first roller via a gap, the gap between the first roller and the second roller, the method including adjusting the size of the gap by moving the second roller in a direction further away from the first roller such that the gap between the first roller and the second roller in a direction orthogonal to the axis direction of the second roller increases.

An embodiment is explained below with reference to the accompanying drawings.

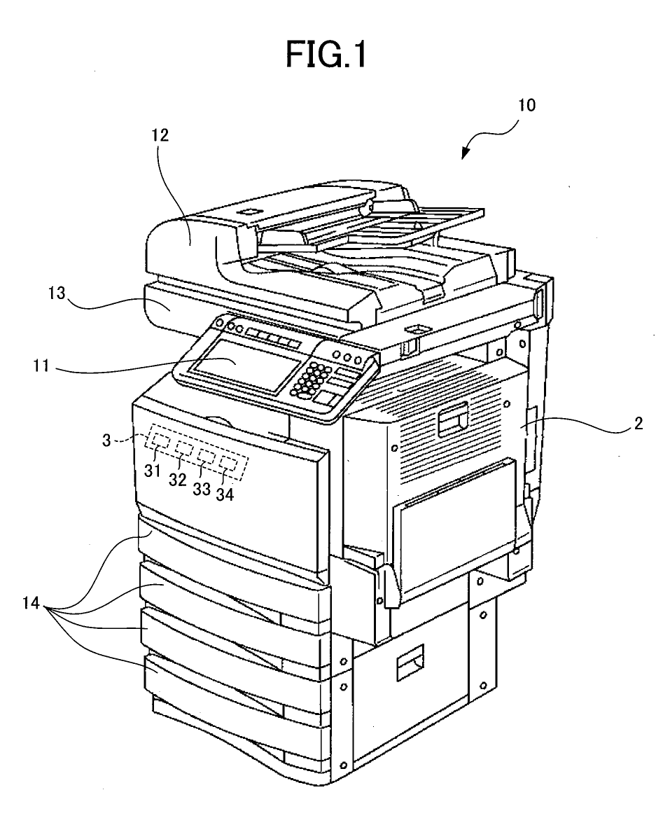

FIG. 1 is a perspective view of an image forming apparatus 10.

The image forming apparatus 10 is a MFP (Multi Function Peripheral). The image forming apparatus 10 includes a touch panel 11, an ADF (Auto Document Feeder) 12, an image reading section 13, paper feeding cassettes 14, an image forming section 2, and a control section 3.

The touch panel 11 serves as both a display section and an operation input section. As the display section, an LCD (Liquid Crystal Display), an EL (Electronic Luminescence), a PDP (Plasma Display Panel), or a CRT (Cathode Ray Tube) may be used. As the operation input section, a keyboard or a mouse may be used.

The control section 3 controls the entire image forming apparatus 10. The control section 3 includes a processor 31, an ASIC (Application Specific Integrated Circuit) 32, a memory 33, and a HDD (Hard Disk Drive) 34. The processor 31 executes computer programs stored in the memory 33 and realizes various functions. The processor 31 may be a CPU (Central Processing Unit) or a MPU (Micro Processing Unit). The memory 33 may be a RAM (Random Access Memory), a ROM (Read Only Memory), a DRAM (Dynamic Random Access Memory), an SRAM (Static Random Access Memory), or a VRAM (Video RAM). The HDD 34 may be a flash memory. The ASIC 32 may perform a part of the functions realized by the processor 31.

The image forming apparatus 10 reads a sheet set on the ADF 12 with the image reading section 13 according to, for example, an operation input to the touch panel 11 by a user and generates a print job including image data and commands for the number of prints and the like. The image forming apparatus 10 feeds a sheet in the paper feeding cassettes 14 to the image forming section 2 and forms an image on the sheet with the image forming section 2 on the basis of the print job. The image forming apparatus 10 also forms an image on the sheet on the basis of a print job transmitted from an external apparatus.

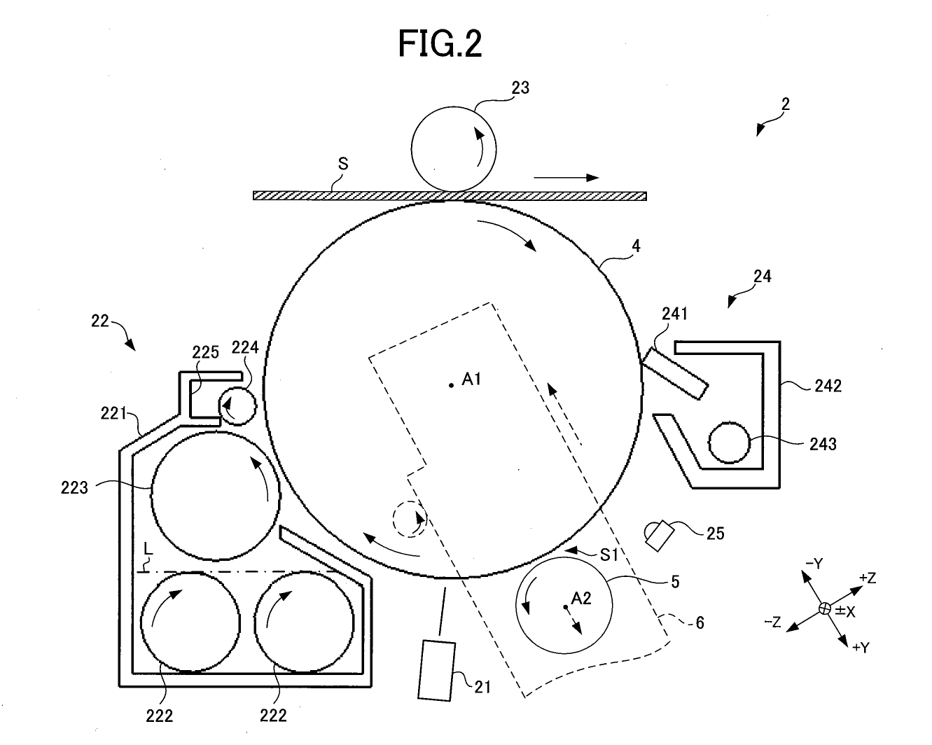

FIG. 2 is a schematic diagram of the image forming section 2.

The image forming section 2 includes a photoconductive member 4 (a first roller, a contact and separation section), a charging roller 5 (a second roller), an exposure unit 21, a developing device 22, a transfer member 23, a cleaning device 24, an optical charge removing device 25, and a separating mechanism 6. In figures referred to below, an axis direction of the charging roller 5 is represented as X direction. In the figures, a direction orthogonal to the X direction and connecting a center axis A1 of the photoconductive member 4 and a center axis A2 of the charging roller 5 is represented as Y direction. In the figures, in the Y direction, a direction in which the charging roller 5 separates from the photoconductive member 4 is represented as +Y direction and a direction in which the charging roller 5 approaches the photoconductive member 4 is represented as −Y direction. In the figures, a direction orthogonal to the X and Y directions is represented as Z direction.

The charging roller 5 is arranged to be opposed to the photoconductive member 4 via a very small gap S1. The gap S1 is set to be, for example, equal to or smaller than 50 μm. When, for example, a bias voltage having negative polarity is applied to the charging roller 5, the charging roller 5 discharges in the gap S1 and uniformly negatively charges the photoconductive member 4.

The exposure unit 21 scans the photoconductive member 4 with a laser beam and forms an electrostatic latent image on the photoconductive member 4. In a region exposed by the laser beam on the photoconductive member 4, negative charges are removed according to the intensity of the laser beam and negative potential is lower than negative potential around the region. On the photoconductive member 4, the electrostatic latent image is formed from a section where negative potential is lower than negative potential around the section.

The developing device 22 includes a development container 221, an agitating member 222, a developing roller 223, and a cleaning roller 224. The development container 221 houses the members 222 to 224 and a developer. An imaginary line L shown in FIG. 2 is an interface L of the developer. As the developer, in this embodiment, a two-component developer including a toner and a carrier is used. However, a one-component developer including only a toner may be used. The agitating member 222 agitates the developer in the development container 221 and negatively triboelectrically charges the toner. The developing roller 223 includes a rotatably-supported cylinder and a magnet roller provided on the inside of the cylinder and fixed to the development container 221. The developing roller 223 attracts the toner to the outer circumferential surface thereof with magnetic force. The toner attracted to the outer circumferential surface of the developing roller 223 stands like the ears of rice along a line of magnetic force and forms a magnetic brush. The cylinder of the developing roller 223 allows the magnetic brush to rub the photoconductive member 4 or brings the magnetic brush close to the photoconductive member 4 while rotating to thereby supply a negative toner to the electrostatic latent image on the photoconductive member 4 and develop the electrostatic latent image and forms a toner image on the photoconductive member 4.

When the toner is accumulated on the developing roller 223, coagulation or the like of the toner occurs and image quality is deteriorated. Therefore, a residual toner on the developing roller 223 is cleaned by the cleaning roller 224. Like the developing roller 223, the cleaning roller 224 is configured to be magnetized. The cleaning roller 224 attracts the residual toner on the developing roller 223 while rotating. The toner attracted onto the cleaning roller 224 is scraped off the cleaning roller 224 by a blade or the like. The toner scraped off the cleaning roller 224 is stored in a toner storing section 225 formed in the development container 221.

The transfer member 23 is, for example, a roller made of metal. When a positive bias voltage is applied to the transfer member 23, a transfer electric field is formed between the transfer member 23 and the photoconductive member 4. The toner image on the photoconductive member 4 is transferred onto a transfer receiving member S by the transfer electric field. If the transfer receiving member S is a sheet, fixing processing for heating and pressing the transfer receiving member S is applied to the transfer receiving member S to fix the toner image on the transfer receiving member S. If the transfer receiving member S is a transfer roller or a transfer belt, after the toner image on the transfer receiving member S is transferred onto a sheet via the transfer receiving member, the fixing processing is applied to the sheet to fix the toner image on the sheet.

The cleaning device 24 includes a cleaning blade 241 configured to scrape off the residual toner on the photoconductive member 4, a housing 242 configured to temporarily store the scraped-off residual toner, and a discharge screw 243 configured to discharge the toner in the housing 242 to a toner collection container on the outside of the housing 242. When the cleaning ability of the cleaning blade 241 falls because of long-time use, environmental fluctuation, or the like, the toner and an externally added agent or the like including particles smaller than those of the toner slip through the cleaning blade 241. When foreign matters slipped through the cleaning blade 241 and adhering to the photoconductive member 4 or the toner and foreign matters such as paper powder floating in the image forming apparatus 10 and adhering to the charging roller 5 with electrostatic force or the like are caught between the photoconductive member 4 and the charging roller 5, an image failure is caused.

The optical charge removing device 25 irradiates light on the photoconductive member 4 and removes negative charges remaining on the photoconductive member 4.

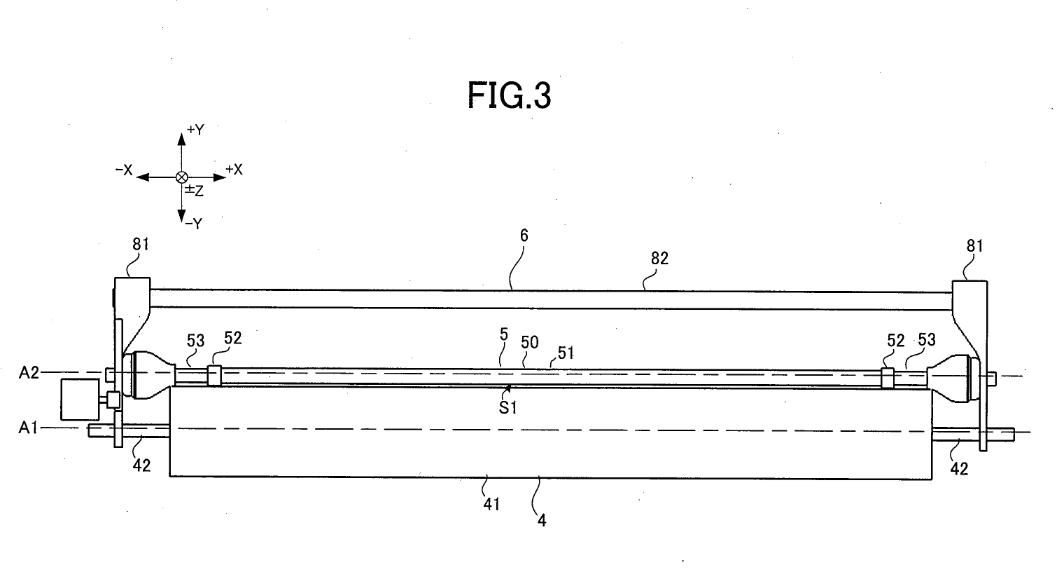

FIG. 3 is a diagram of the photoconductive member 4, the charging roller 5, and the separating mechanism 6 viewed from a direction orthogonal to the longitudinal direction of the components 4 to 6.

The photoconductive member 4 is formed in a longitudinal shape. The photoconductive member 4 includes a photoconductive member body 41 (a first roller body) arranged in parallel to the charging roller 5 via a very small gap S1 and photoconductive member shaft sections 42 (first roller shaft sections) extending in the axis direction of the photoconductive member body 41 and configured to rotate integrally with the photoconductive member body 41. On the outer circumferential surface of the photoconductive member body 41, the center side used for transfer onto the transfer receiving member S is a photoconductive surface of an OPC (Organic Photo Conductor) or the like. The photoconductive member shaft sections 42 are rotatably supported by a shaft bearing section and regulated from moving in the axis direction and a direction orthogonal to the axis direction. The center axes of the photoconductive member body 41 and the photoconductive member shaft sections 42 are present on the same axis A1.

The charging roller 5 is formed a longitudinal shape. The charging roller 5 includes a charging roller body 51 (a second roller body), spacer sections 52, and charging roller shaft sections 53 (second roller shaft sections). The sections 51 to 53 are sections having different diameters and roles in one stepped shaft. The center axes of the sections 51 to 53 are present on the same axis A2.

The charging roller body 51 is arranged in parallel to the photoconductive member body 41 via a very small gap S1. The length in the axis direction of the charging roller body 51 is smaller than the length in the axis direction of the photoconductive member body 41. On the outer circumferential surface of the charging roller body 51, a conductive layer electrically connected to the charging roller shaft section 53 is provided. When a bias voltage is applied to the charging roller shaft sections 53, the charging roller body 51 discharges in the gap S1 and charges the photoconductive member body 41.

The spacer sections 52 are provided on both the outer sides of the charging roller body 51 in the axis direction of the charging roller 5. A sectional external shape orthogonal to the axis direction of the charging roller 5 is a circular shape. The spacer sections 52 have a diameter larger than the diameter of the charging roller body 51. The spacer sections 52 comes into contact with the photoconductive member body 41 and keeps the gap S1 between the photoconductive member body 41 and the charging roller body 51.

The charging roller shaft sections 53 are provided on both the outer sides of the spacer sections 52 in the axis direction of the charging roller 5. The charging roller shaft sections 53 extend to the outer sides in the axis direction of the charging roller body 51 and rotate integrally with the charging roller body 51.

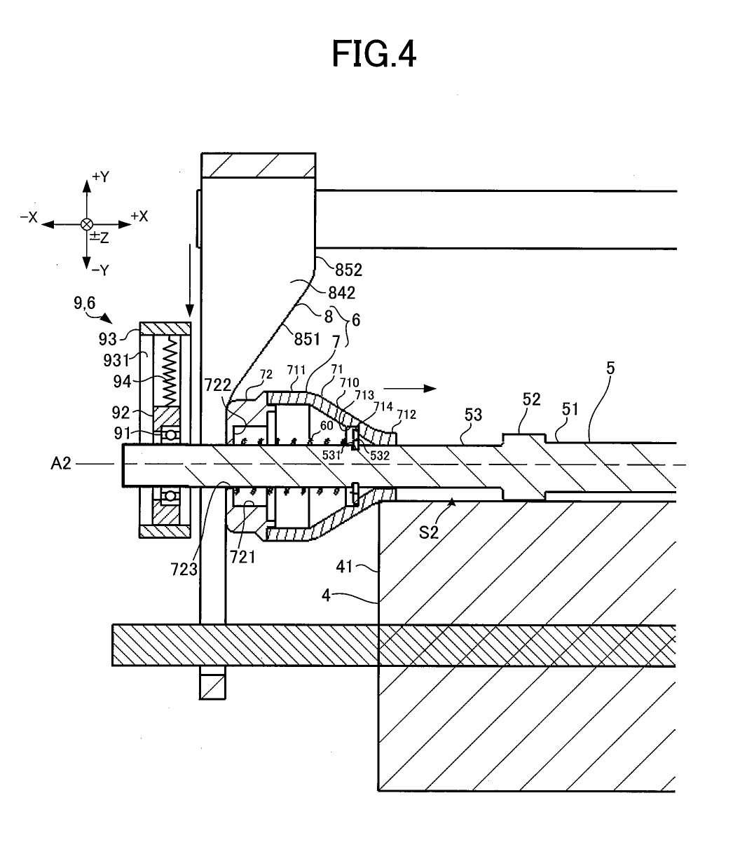

FIG. 4 is an enlarged sectional view of the charging roller shaft section 53 and the separating mechanism 6.

The charging roller shaft section 53 has a diameter smaller than the diameter of the charging roller body 51. One groove 531 is provided in the charging roller shaft section 53. An annular and tabular spring bearing 532 is fit in the groove 531.

The separating mechanism 6 includes a bearing section 9, a conical surface section 7 (a first slope section), and a conical surface moving mechanism 8 (a slope moving mechanism).

A pair of the bearing sections 9 are provided. The pair of bearing sections 9 support the ends of the rotating charging roller 5 and guide the charging roller 5 in the Y direction orthogonal to the axis direction of the charging roller 5. An appropriate configuration can be adopted as the configuration of the bearing section 9. In this embodiment, the bearing section 9 includes a bearing 91, a holding section 92, a guide section 93, and a spring 94. The bearing 91 rotatably supports the shaft section 53 of the charging roller 5. The holding section 92 is formed in a frame shape and holds the bearing 91 on the inside thereof. The guide section 93 is a member fixed to a housing configured to house the photoconductive member 4 and the like or is a part of the housing. A hole 931 extending in the Y direction and piercing through the guide section 93 in the X direction is provided in the guide section 93. One end of the spring 94 is connected to an end in the +Y direction on the wall surface of the hole 931. The other end of the spring 94 is connected to the holding section 92. The spring 94 presses the holding section 92 in the −Y direction.

The conical surface section 7 is formed in a box shape. The charging roller shaft section 53 is inserted through the conical surface section 7. A pair of the conical surface sections 7 are provided. The pair of conical surface sections 7 are located on the charging roller shaft sections 53 and in positions opposed to the photoconductive member shaft sections 42 in the charging roller 5 (FIG. 3). The conical surface section 7 can move in the axis direction on the charging roller shaft section 53. The conical surface section 7 can rotate relatively to the charging roller 5. The conical surface section 7 may be configured to rotate together with the charging roller 5. The conical surface section 7 includes a conical surface 710 that tilts with respect to the center axis A2 of the charging roller 5. Specifically, the conical surface 710 is formed as a circular truncated cone surface. A circular truncated cone means a solid body obtained by cutting a cone along a plane orthogonal to the axis of the cone and removing a small cone formed on the distal end side from the cone. The outer surface of the circular truncated cone includes a side surface and a top surface and a bottom surface orthogonal to the axis of the circular truncated cone. The circular truncated cone surface means the side surface of the outer surface of the circular truncated cone. A side closer to the center axis, i.e., the distal end side of the conical surface section 7 is present on the charging roller body 51 side. When the charging roller 5 is present in a charging position shown in FIG. 4 where the charging roller 5 charges the photoconductive member 4, the conical surface section 7 is present in a position where the distal end of the conical surface 710 is in contact with an end in the axis direction and an end in the radial direction of the photoconductive member body 41 or a position where a very small gap is formed between the distal end of the conical surface 710 and the end in the axis direction and the end in the radial direction of the photoconductive member body 41.

The conical surface section 7 includes a circular truncated cone-shaped cylinder 71 and a cover 72.

The circular truncated cone-shaped cylinder 71 is a cylinder having a circular truncated cone shape and has the conical surface 710 and a circumferential surface 711. The circumferential surface 711 is formed in a circular shape centering on the center axis of the conical surface section 7. The circumferential surface 711 continues to the rear end of the conical surface 710. The distal end of the circular truncated cone-shaped cylinder 71 is formed as a sleeve section 712 through which the charging roller shaft section 53 is inserted. When the charging roller 5 is present in the charging position, the sleeve section 712 is present in a gap S2 between the charging roller shaft section 53 and the photoconductive member body 41. One groove 713 is provided on the inner surface of the circular truncated cone-shaped cylinder 71 on the rear side of the conical surface 710.

The cover 72 is fit in an opening provided at the rear end of circular truncated cone-shaped cylinder 71 and closes the opening. A recess 721 is provided on the inner side of the cover 72. A hole 723 through which the charging roller shaft section 53 is inserted is provided on a bottom surface 722 of the recess 721.

The conical surface sections 7 are moved to the center side of the charging roller 5 by the conical surface moving mechanism 8 and slip into between the charging roller 5 and the photoconductive member 4. The conical surface sections 7 move the charging roller 5 in the +Y direction further away from the photoconductive member 4 such that the gap between the charging roller 5 and the photoconductive member 4 in the Y direction increases.

A spring 60 through which the charging roller shaft section 53 is inserted is provided on the inside of the conical surface section 7. In a compressed state, the spring 60 is supported by the bottom surface 722 of the conical surface section 7 and the spring bearing 532. Specifically, one end of the spring 60 is connected to the conical surface section 7 and the other end of the spring 60 is connected to the charging roller 5 via the spring bearing 532. When the charging roller 5 is present in the charging position shown in FIG. 4, the conical surface section 7 is subjected to force to the outer side in the axis direction of the charging roller 5 (in FIG. 4, in the −X direction) by the spring 60. The spring bearing 532 comes into contact with the side surface 714 of the groove 713 on the inner surface, whereby the conical surface section 7 is positioned. When the conical surface section 7 moves to the center side of the charging roller 5 (in FIG. 4, in the +X direction), the spring 60 is further compressed and applies force to the conical surface section 7 for returning the conical surface section 7 to the end side of the charging roller 5 (in FIG. 4, in the −X direction).

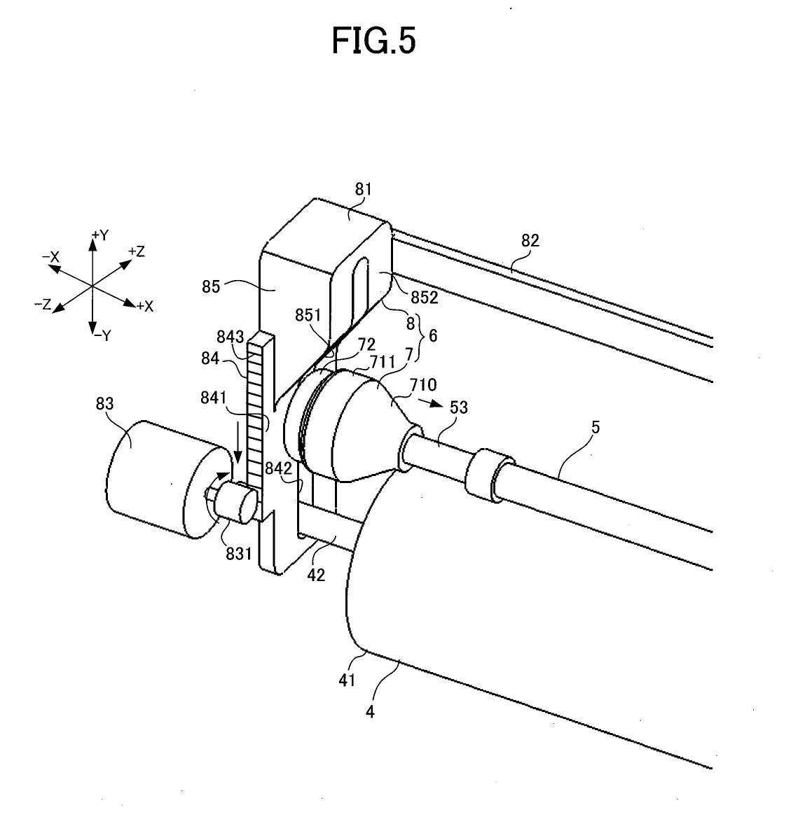

FIG. 5 is a perspective view of the conical surface moving mechanism 8.

The conical surface moving mechanism 8 includes a moving mechanism body 81, a connecting member 82, and a motor 83 (a driving section).

A pair of the moving mechanism bodies 81 are provided and connected to each other by the connecting member 82 (FIG. 3). The moving mechanism body 81 are guided by a guide member to be movable only in the Y direction. The moving mechanism body 81 includes a guide section 84 and a slope section 85 (a second slope section).

The guide section 84 is formed in a flat shape. A surface on the inner side of the guide section 84 is formed as a guide surface 841 parallel to the Y direction. The guide surface 841 supports the bottom surface section of the conical surface section 7 (a side separating from the photoconductive member body 41 in the conical surface section 7) and guides the bottom surface section of the conical surface section 7 in the Y direction. The guide surface 841 includes a linear long hole 842 extending in the Y direction. The respective shaft sections 53 and 42 of the charging roller 5 and the photoconductive member 4 are inserted through the long hole 842. A rack 843 having plural teeth is provided on only a side surface of the guide section 84 of one moving mechanism body 81 shown in FIG. 5 of the pair of moving mechanism bodies 81. The motor 83 causes, under the control by the control section 3, a pinion gear 831 meshing with the rack 843 to pivot and causes one moving mechanism body 81 to move back and forth in the Y direction. Consequently, the other moving mechanism body 81 connected to one moving mechanism body 81 via the connecting member 82 also moves back and forth in the Y direction in the same manner as one moving mechanism body 81.

The slope sections 85 of the moving mechanism bodies 81 further swell to the photoconductive member body 41 side in the X direction than the guide section 84. The slope section 85 includes a slope 851 that is connected to the guide surface 841 and tilts with respect to the Y direction and a pressing surface 852 that continues to the +Y direction end of the slope 851 and is parallel to the Y direction. In the slope 851 and the pressing surface 852, the long hole 842 extends in the +Y direction from the guide surface 841. The long hole 842 pierces through the slope section 85 in the X direction (FIG. 4).

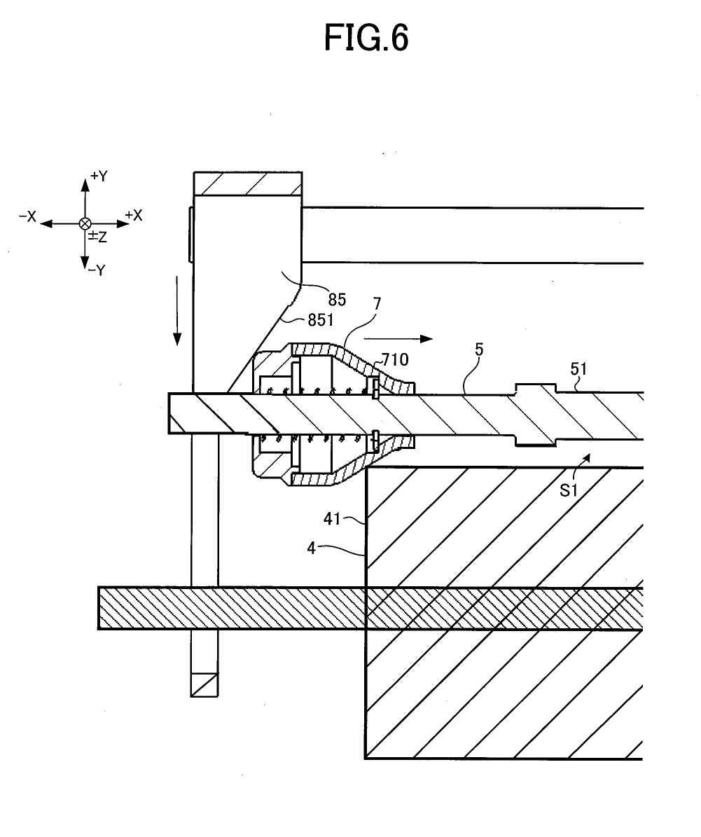

When the charging roller 5 is present in the charging position shown in FIG. 5, the slope section 85 is present further in the +Y direction than the conical surface section 7. When the motor 83 moves the guide section 84 in the −Y direction, the slope sections 85 of the moving mechanism bodies 81 also move in the −Y direction. As shown in FIG. 6, the slope sections 85 bring the slopes 851 into contact with the bottom surface sections of the conical surface sections 7 and move the conical surface sections 7 to a side approaching the photoconductive member body 41 in the X direction (in FIG. 6, in the +X direction).

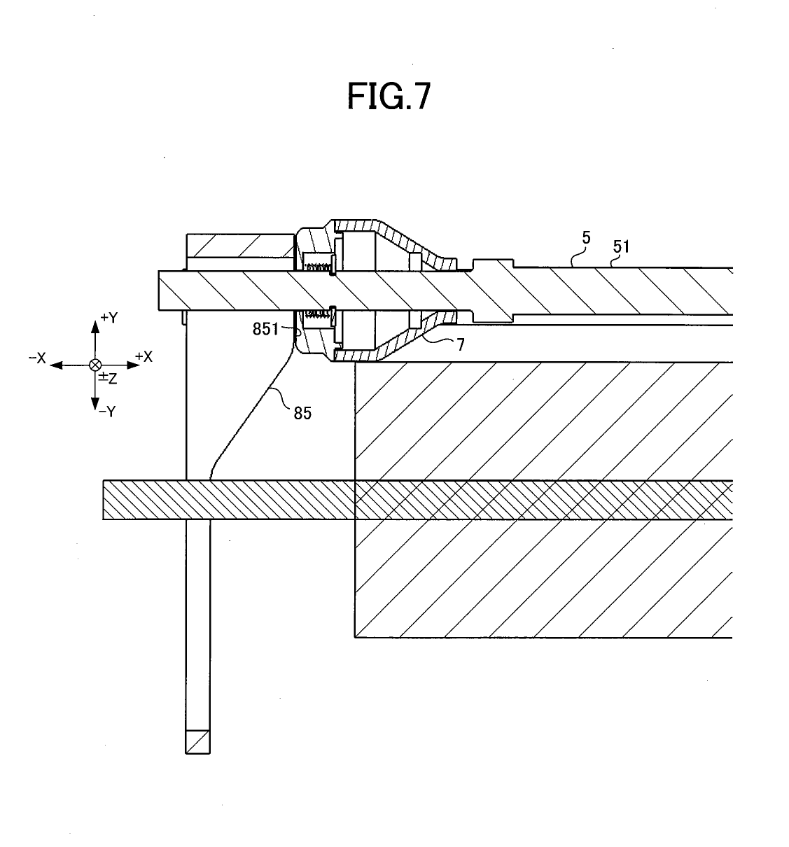

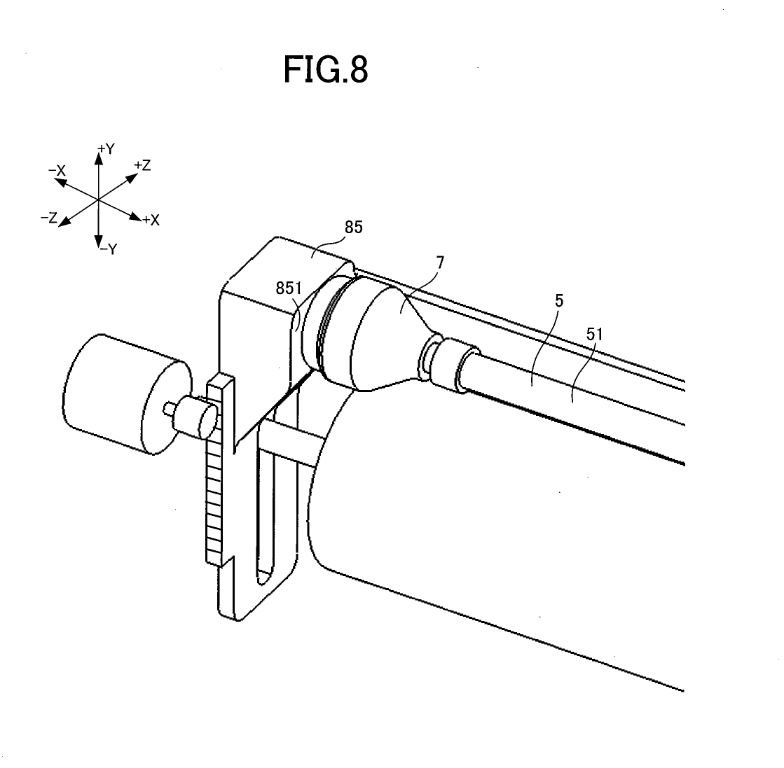

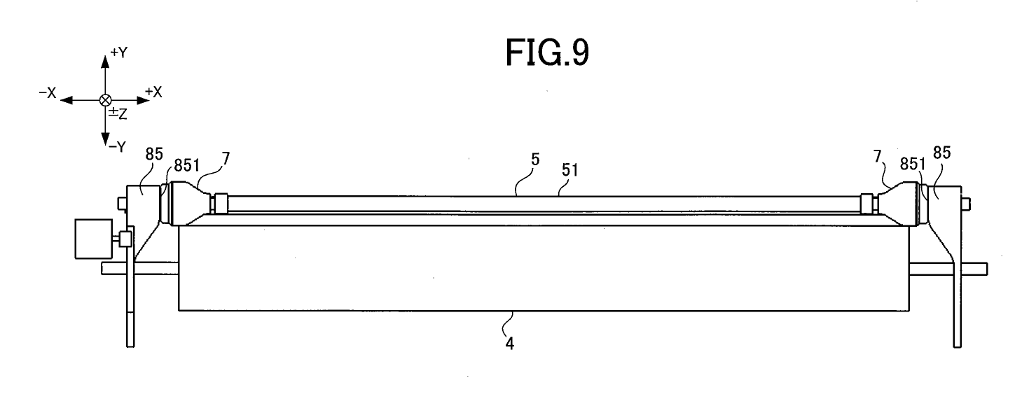

When the conical surface sections 7 are moved, the conical surfaces 710 of the conical surface sections 7 move in the X direction while being into contact with the ends in the axis direction of the photoconductive member body 41. However, since the conical surfaces 710 tilt in the Y direction, the conical surface sections 7 also move in the +Y direction while moving in the X direction and move the charging roller 5 in the +Y direction. The conical surface sections 7 push the charging roller 5 in the +Y direction to thereby translate the charging roller 5 in the +Y direction away from the photoconductive member 4. As shown in FIGS. 7 to 9, at the maximum, the conical surface sections 7 are pushed by the slope sections 85 in the −Y direction and to the side approaching the photoconductive member body 41 in the X direction (in FIGS. 7 and 8, in the +X direction) until the conical surface sections 7 run onto the pressing surfaces 852 of the slope sections 85.

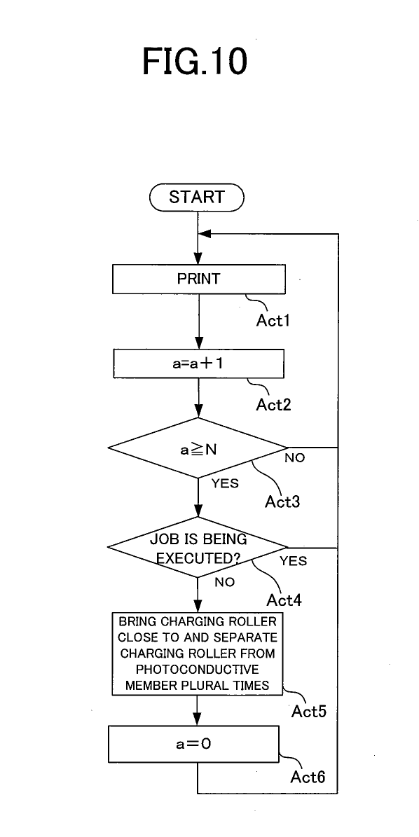

Control for adjusting a gap between the charging roller 5 and the photoconductive member 4 by the control section 3 is explained below with reference to a flowchart of FIG. 10. The control by the control section 3 is realized by the processor 31 reading a computer program stored in the memory 33 and controlling the sections of the image forming apparatus 10. The ASIC 32 may realize a part of the control.

When a print job is input, for example, from the outside, the control section 3 forms an image on a sheet with the image forming section 2 on the basis of the print job (Act 1). The control section 3 adds 1 to a count value “a” every time the image is output and counts the number of image-output sheets (Act 2). The control section 3 determines whether the count value “a” of the number of image-output sheets is equal to or larger than a threshold N (e.g., 5000) (Act 3). If the count value “a” is smaller than the threshold N (NO in Act 3), the control section 3 returns to Act 1. If the count value “a” is equal to or larger than the threshold N (YES in Act 3), the control section 3 determines whether the print job is being executed (Act 4). If the print job is being executed (YES in Act 4), the control section 3 repeats Acts 1 to 4. If the print job ends (NO in Act 4), the control section 3 drive-controls the motor 83 to thereby move the charging roller 5 in the +Y direction away from the photoconductive member 4 and then bring the charging roller 5 close to and separate the charging roller 5 from the photoconductive member 4 plural times (Act 5). Specifically, the control section 3 drive-controls the motor 83, causes the slope sections 85 to move back and forth in the Y direction, and causes the conical surface sections 7 to move back and forth in the X direction to thereby bring the charging roller 5 close to and separate the charging roller 5 from the photoconductive member 4 in the Y direction plural times.

When the charging roller 5 is brought close to and separated from the photoconductive member 4, in this embodiment, the charging roller 5 is moves in the +Y direction away from the photoconductive member 4 and the gap S1 between the charging roller 5 and the photoconductive member 4 is increased. Therefore, the toner and foreign matters such as powder dust caught in the gap S1 can be removed from the gap S1.

In this embodiment, since the charging roller 5 is caused to move back and forth in the Y direction plural times, it is possible to shake off foreign matters adhering to the charging roller 5 and effectively remove the foreign matters from the gap S1.

In this embodiment, the charging roller 5 is separated from the photoconductive member 4 by pressing the conical surface section 7 against the photoconductive member 4. In this embodiment, the conical surface section 7 is rotatable and the outer circumferential surface of the conical surface section 7 is formed as the conical surface 710. Therefore, even if the conical surface 710 is pressed against the photoconductive member 4 while the photoconductive member 4 is rotating, it is possible to minimize scratching of the conical surface 710 by the photoconductive member 4.

In this embodiment, it is possible to stop the pressing of the conical surface 710 against the photoconductive member 4 halfway in the conical surface 710 and it is possible to reduce a separation amount of the charging roller 5 from the photoconductive member 4 to be very small. Therefore, it is possible to slightly separate the charging roller 5 from the photoconductive member 4 between print jobs. When the charging roller 5 is separated from the photoconductive member 4 during executing of a print job, it is possible to slightly separate the charging roller 5 from the photoconductive member 4 between printing on one sheet and printing on another in the same print job.

After Act 5, the control section 3 sets the count value “a” of the number of image-output sheets to 0 (Act 6) and returns to Act 1.

### Modifications

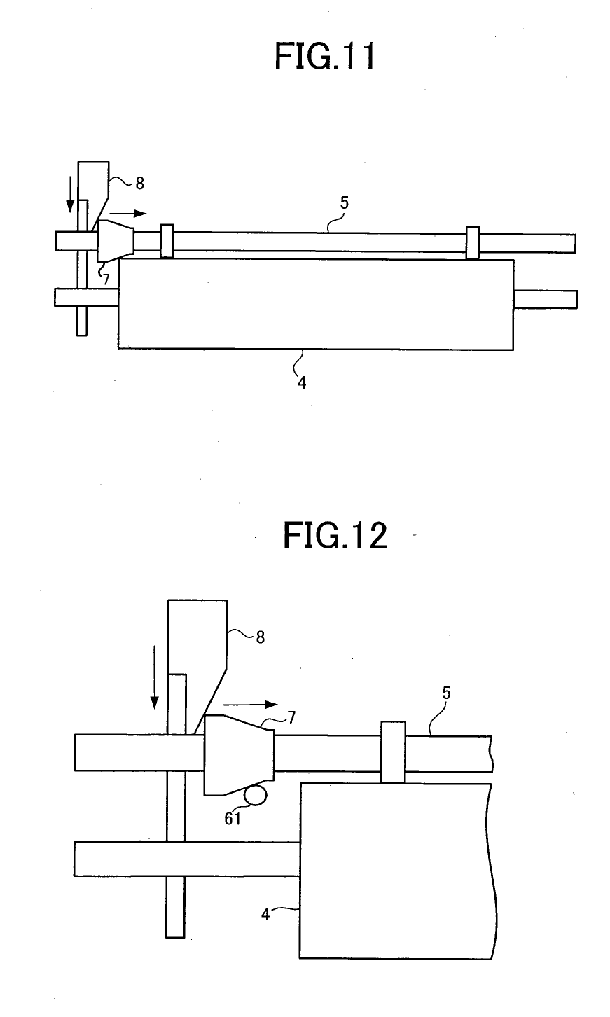

In the embodiment, the conical surface sections 7 support both the ends of the charging roller 5. However, as shown in FIG. 11, the conical surface section 7 may support only one side of the charging roller 5.

In the embodiment, the contact and separation section that comes into contact with the conical surface section 7 is the photoconductive member 4. However, as shown in FIG. 12, a contact and separation section 61 may be provided separately from the photoconductive member 4. For example, the contact and separation section 61 may be a column extending in a depth direction of the paper surface of FIG. 12.

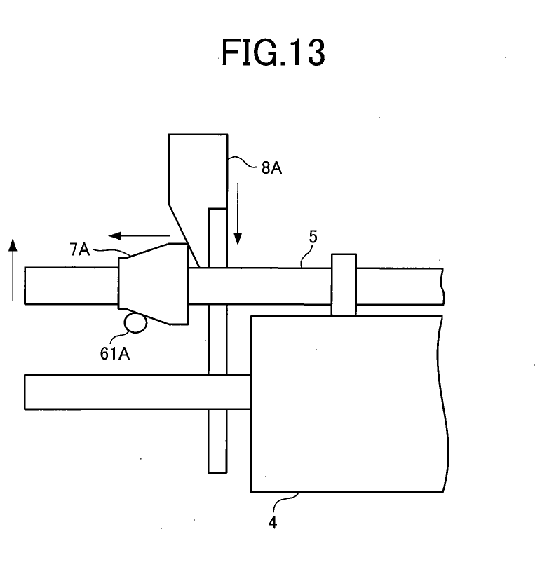

In a modification shown in FIG. 12, the contact and separation section 61 is provided near the center side of the charging roller 5. The conical surface section 7 moves to the center side of the charging roller 5 in the axis direction of the charging roller 5 to thereby separate the charging roller 5 from the photoconductive member 4. However, as shown in FIG. 13, a contact and separation section 61A may be provided near an end side of the charging roller 5 in the axis direction of the charging roller 5. A conical surface section 7A may move to the end side of the charging roller 5 to thereby separate the charging roller 5 from the photoconductive member 4.

In this embodiment, the separating mechanism separates the charging roller 5 from the photoconductive member 4. However, the separating mechanism may separate the cleaning roller 224 from the developing roller 223.

In the embodiment, the conical surface section 7 serving as the first slope section is rotatable with respect to the photoconductive member 4 and has the conical surface 710 as the first slope section. However, the first slope section only has to move in the axis direction of the charging roller 5 and does not have to be rotatable with respect to the photoconductive member 4. The first slope section does not have to be the conical surface 710 and only has to be a flat-shaped slope that tilts with respect to the center axis A2 of the charging roller 5.

A form of a recording medium may be any form as long as the recording medium is a recording medium that can store a computer program and can be read by a computer. Specifically, examples of the recording medium include an internal storage device internally mounted in a computer such as a ROM or a RAM, a portable storage medium such as a CD-ROM, a flexible disk, a DVD disk, a magneto-optical disk, or an IC card, a database that stores a computer program, and other computers and databases for the computers. Functions obtained by installation and download may cause an OS or the like in an apparatus to realize the functions in cooperation with the OS or the like. The computer program may be an execution module that is dynamically generated partially or entirely.

The order of the kinds of processing in the embodiment may be different from the order illustrated in the embodiment.

As explained above in detail, according to the technique described in this specification, it is possible to provide a technique for adjusting a gap between rollers.

While certain embodiments have been described, these embodiments have been presented by way of example only, and are not intended to limit the scope of invention. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An image forming apparatus comprising:
a first roller formed in a longitudinal shape;
a second roller formed in a longitudinal shape and arranged in parallel to the first roller via a gap; and
a separating mechanism configured to move the second roller in a direction further away from the first roller such that the gap between the first roller and the second roller in a direction orthogonal to an axis direction of the second roller increases.

2. The apparatus according to claim 1, wherein the separating mechanism includes:
a bearing section configured to support the rotating second roller and guide the second roller in the direction orthogonal to the axis direction of the second roller;
a first slope section including a first slope that tilts with respect to a center axis of the second roller, regulated from moving in the direction orthogonal to the axis direction of the second roller by the second roller, and configured to move in the axis direction of the second roller;
a slope moving mechanism configured to move the first slope section in the axis direction of the second roller; and
a contact and separation section configured to come into contact with the first slope section when the first slope section moves in the axis direction of the second roller and move the first slope section in the direction orthogonal to the axis direction of the second roller.

3. The apparatus according to claim 2, wherein the first slope is a conical surface that extends to an outer side in a radial direction of the second roller centering on the center axis of the second roller.

4. The apparatus according to claim 2, wherein
the first roller includes:
a first roller body serving as the contact and separation section arranged in parallel to the second roller via a gap; and
a first roller shaft section having a diameter smaller than a diameter of the first roller body and configured to rotate integrally with the first roller body, and
the first slope section is located in a position where the first slope is opposed to the first roller shaft section in the second roller, moved to a side approaching the first roller body in the axis direction of the second roller by the slope moving mechanism, and comes into contact with an end in an axis direction of the first roller body.

5. The apparatus according to claim 2, wherein the separating mechanism includes an elastic member, one end of which is connected to the second roller and the other end of which is connected to the first slope section, the elastic member applying, when the slope moving mechanism moves the first slope section to a side approaching the contact and separation section in the axis direction of the second roller, force to the first slope section in a direction away from the contact and separation section in the axis direction of the second roller.

6. The apparatus according to claim 5, wherein
the first slope section is provided in a box shape and the second roller is inserted through the first slope section, and
the elastic member is provided on an inside of the first slope section.

7. The apparatus according to claim 6, wherein the first slope section is formed in a circular truncated cone shape.

8. The apparatus according to claim 2, wherein the slope moving mechanism includes a second slope section including a second slope that tilts with respect to the direction orthogonal to the axis direction of the second roller and configured to move in the direction orthogonal to the axis direction of the second roller, bring the second slop into contact with a side separating from the contact and separation section of the first slope section, and move the first slope section to a side approaching the contact and separation section in the axis direction of the second roller.

9. The apparatus according to claim 8, wherein the slope moving mechanism includes:
a guide section including a guide surface formed in a linear shape extending in the direction orthogonal to the axis direction of the second roller, having a long hole through which axes of the first and second rollers are inserted, and configured to support the side separating from the contact and separation section of the first slope section;
the second slope section including the second slope connected to the guide surface, the long hole extending in the direction in the second slope; and
a driving section configured to move the guide section and the second slope section in the direction.

10. The apparatus according to claim 1, wherein the second roller includes:
a roller body arranged in parallel to the first roller via a gap; and
spacer sections provided on both outer sides of the roller body in the axis direction of the second roller and configured to come into contact with the first roller and keep the gap between the roller body and the first roller.

11. The apparatus according to claim 1, further comprising a control section configured to control driving of the separating mechanism and bring the second roller close to and separate the second roller from the first roller plural times.

12. The apparatus according to claim 1, further comprising a control section configured to control driving of the separating mechanism and separate the second roller from the first roller when a job is not executed.

13. The apparatus according to claim 1, wherein
the first roller is a photoconductive member, and
the second roller is a charging roller.

14. The apparatus according to claim 1, wherein
the first roller is a developing roller configured to supply a toner to a photoconductive member and develop an electrostatic latent image on the photoconductive member, and
the second roller is a cleaning roller configured to remove a residual toner on a surface of the developing roller from the surface of the developing roller.

15. A method of adjusting, in an image forming apparatus including a first roller formed in a longitudinal shape and a second roller formed in a longitudinal shape and arranged in parallel to the first roller via a gap, the gap between the first roller and the second roller, the method comprising adjusting size of the gap by moving the second roller in a direction further away from the first roller such that the gap between the first roller and the second roller in a direction orthogonal to an axis direction of the second roller increases.

16. The method according to claim 15, wherein the separating mechanism includes:
a bearing section configured to support the rotating second roller and guide the second roller in the direction orthogonal to the axis direction of the second roller;
a first slope section including a first slope that tilts with respect to a center axis of the second roller, regulated from moving in the direction orthogonal to the axis direction of the second roller by the second roller, and configured to move in the axis direction of the second roller;
a slope moving mechanism configured to move the first slope section in the axis direction of the second roller; and
a contact and separation section configured to come into contact with the first slope section when the first slope section moves in the axis direction of the second roller and move the first slope section in the direction orthogonal to the axis direction of the second roller.

17. The method according to claim 16, wherein the first slope is a conical surface that extends to an outer side in a radial direction of the second roller centering on the center axis of the second roller.

18. The method according to claim 16, wherein
the first roller includes:
a first roller body serving as the contact and separation section arranged in parallel to the second roller via a gap; and
a first roller shaft section having a diameter smaller than a diameter of the first roller body and configured to rotate integrally with the first roller body, and
the first slope section is located in a position where first slope is opposed to the first roller shaft section in the second roller, moved to a side approaching the first roller body in the axis direction of the second roller by the slope moving mechanism, and comes into contact with an end in an axis direction of the first roller body.

19. The method according to claim 16, wherein the separating mechanism includes an elastic member, one end of which is connected to the second roller and the other end of which is connected to the first slope section, the elastic member applying, when the slope moving mechanism moves the first slope section to a side approaching the contact and separation section in the axis direction of the second roller, force to the first slope section in a direction away from the contact and separation section in the axis direction of the second roller.

20. The method according to claim 19, wherein
the first slope section is provided in a box shape and the second roller is inserted through the first slope section, and
the elastic member is provided on an inside of the first slope section.
